(19) United States
(12) Patent Application Publication
(10) Pub. No.: US 2024/0377768 A1
(43) Pub. Date: Nov. 14, 2024

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Ryota KANEKO, Kanagawa (JP); Michinori FUKUMA, Kanagawa (JP); Hiroaki OGAWA, Kanagawa (JP)

(73) Assignee: FUJIFILM Business Innovation Corp., Tokyo (JP)

(21) Appl. No.: 18/782,410

(22) Filed: Jul. 24, 2024

(30) Foreign Application Priority Data
Mar. 6, 2024 (JP) 2024-034365

(51) Int. Cl. G03G 5/087; G03G 5/147

(52) U.S. Cl. CPC G03G 5/087; G03G 5/14704; G03G 2215/00957; G03G 2215/00962; G03G 2221/183

(57) ABSTRACT

An electrophotographic photoreceptor includes a conductive substrate, a photosensitive layer provided on or above the conductive substrate and containing inorganic oxide particles, and an inorganic protective layer provided on the photosensitive layer. In a particle size distribution of the inorganic oxide particles obtained through cross-sectional observation of the photosensitive layer, the highest peak for small-diameter particles A is present in the range of 20 nm to 50 nm, and the highest peak for large-diameter particles β is present in the range of 80 nm to 400 nm, with the threshold particle diameter for the small-diameter particles A and the large-diameter particles β being 60 nm, and the relationship between the particle diameter dA at the highest peak for the small-diameter particles A and the particle diameter dB at the highest peak for the large-diameter particles β satisfies formula (A1) below:

$$dB / dA \geq 4. . \qquad ( A1 )$$

### CROSS-REFERENCE TO RELATED APPLICATIONS

This application is based on and claims priority under 35 USC 119 from Japanese Patent Application No. 2024-034365 filed Mar. 6, 2024.

### BACKGROUND

### (i) Technical Field

The present disclosure relates to an electrophotographic photoreceptor, a process cartridge, and an image forming apparatus.

### (ii) Related Art

In Japanese Patent No. 5447062, there is disclosed “an electrophotographic photoreceptor comprising, in this order: a substrate; a photosensitive layer; and a protective layer including oxygen and gallium, the protective layer including a first region that is present at or near the outer circumference surface side and a second region that is present closer to the substrate than the first region and has a ratio of the numbers of atoms (oxygen/gallium) larger than that in the first region.”

In Japanese Unexamined Patent Application Publication No. 2004-286887, there is disclosed “an electrophotographic photoreceptor comprising: a conductive support; and a photosensitive layer and a surface-protecting layer sequentially stacked on the conductive support, the surface-protecting layer including a resin and at least two or more fillers dispersed in the resin, wherein: one of the fillers is fine particles of diamond-like carbon or amorphous carbon having an average particle diameter of 50 nm or less; and at least one other filler is an inorganic filler having an average particle diameter of 0.1 to 1.0 μm.”

### SUMMARY

Aspects of non-limiting embodiments of the present disclosure relate to an electrophotographic photoreceptor that includes a conductive substrate, a photosensitive layer provided on or above the conductive substrate and containing inorganic oxide particles, and an inorganic protective layer provided on the photosensitive layer and that may offer improved break resistance of the inorganic protective layer compared with when in a particle size distribution of the inorganic oxide particles obtained through cross-sectional observation of the photosensitive layer, the highest peak for small-diameter particles A is present in the range of 20 nm to 50 nm, and the highest peak for large-diameter particles β is present in the range of 80 nm to 400 nm, with the threshold particle diameter for the small-diameter particles A and the large-diameter particles β being 60 nm, but the relationship between the particle diameter dA at the highest peak for the small-diameter particles A and the particle diameter dB at the highest peak for the large-diameter particles β does not satisfy formula (A1).

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrophotographic photoreceptor including a conductive substrate; a photosensitive layer provided on or above the conductive substrate and containing inorganic oxide particles; and an inorganic protective layer provided on the photosensitive layer, wherein: in a particle size distribution of the inorganic oxide particles obtained through cross-sectional observation of the photosensitive layer, a highest peak for small-diameter particles A is present in a range of 20 nm to 50 nm, and a highest peak for large-diameter particles β is present in a range of 80 nm to 400 nm, with a threshold particle diameter for the small-diameter particles A and the large-diameter particles β being 60 nm; and a relationship between a particle diameter dA at the highest peak for the small-diameter particles A and a particle diameter dB at the highest peak for the large-diameter particles β satisfies formula (A1) below:

$$dB / dA \geq 4. . \qquad ( A1 )$$

### BRIEF DESCRIPTION OF THE DRAWINGS

Exemplary embodiments of the present disclosure will be described in detail based on the following figures, wherein:

FIG. 1 is a partial cross-sectional view illustrating an example of a layer structure of an electrophotographic photoreceptor according to an exemplary embodiment;

FIG. 2 is a partial cross-sectional view illustrating another example of a layer structure of an electrophotographic photoreceptor according to an exemplary embodiment;

FIG. 3 is a schematic view illustrating the structure of an example of an image forming apparatus according to an exemplary embodiment; and

FIG. 4 is a schematic view illustrating the structure of another example of an image forming apparatus according to an exemplary embodiment.

### DETAILED DESCRIPTION

Exemplary embodiments as examples of the present disclosure will now be described. These descriptions and the Examples are intended to illustrate exemplary embodiments and not intended to limit the scope of the present disclosure.

Numerical ranges specified herein with “A-B,” “between A and B,” “(from) A to B,” etc., represent ranges that include values A and B as the minimum and the maximum, respectively.

In a series of numerical ranges presented herein, an upper or lower limit specified in one numerical range may be substituted with the upper or lower limit of another numerical range in the same series. In a numerical range presented herein, furthermore, the upper or lower limit of the numerical range may be substituted with a value indicated in the Examples.

As used herein, the word “step” refers not only to an independent step; even if a step is not clearly differentiated from another, the step is included in this term as long as its intended purpose is fulfilled.

When an exemplary embodiment is described with reference to a drawing herein, the structure of the exemplary embodiment is not limited to the structure illustrated in the drawing. The size of elements in each drawing, furthermore, is conceptual; the relationship between the sizes of elements is not limited to what is illustrated.

A constituent herein may include multiple substances corresponding to it. When the amount of a constituent in a composition is mentioned herein, and if multiple substances corresponding to the constituent are present in the composition, the mentioned amount represents the total amount of the multiple substances present in the composition unless stated otherwise.

A constituent herein may include multiple types of particles corresponding to it. When multiple types of particles corresponding to a constituent are present in a composition, the particle diameter of the constituent is a value for the mixture of the multiple types of particles present in the composition unless stated otherwise.

As mentioned herein, an alkyl group and an alkylene group encompass all of the linear-chain, branched, and cyclic forms unless stated otherwise.

As mentioned herein, groups such as an organic group, an aromatic ring, a linkage, an alkyl group, an alkylene group, an aryl group, an aralkyl group, an alkoxy group, and an aryloxy group may have one or more of their hydrogen atoms replaced with one or more halogen atoms.

When a compound is indicated with a structural formula herein, it may be indicated with a structural formula in which the symbols for carbon atoms and hydrogen atoms (C and H) in a hydrocarbon group and/or a hydrocarbon chain are omitted.

As used herein, ppm stands for parts per million and is on a mass basis.

As used herein, “the direction along the axis” or “the axial direction” in the context of an electrophotographic photoreceptor refers to the direction in which the rotational axis of the electrophotographic photoreceptor extends, and “the direction along the circumference” or “the circumferential direction” in the context of an electrophotographic photoreceptor refers to the direction in which the electrophotographic photoreceptor rotates.

### Electrophotographic Photoreceptor

An electrophotographic photoreceptor (Hereinafter also referred to as “photoreceptor.”) according to an exemplary embodiment includes a conductive substrate, a photosensitive layer provided on or above the conductive substrate and containing inorganic oxide particles, and an inorganic protective layer provided on the photosensitive layer.

For a photoreceptor according to a first exemplary embodiment, the highest peak, in a particle size distribution of the inorganic oxide particles obtained through cross-sectional observation of the photosensitive layer, for small-diameter particles A is present in the range of 20 nm to 50 nm, and the highest peak for large-diameter particles β is present in the range of 80 nm to 400 nm, with the threshold particle diameter for the small-diameter particles A and the large-diameter particles β being 60 nm, and the relationship between the particle diameter dA at the highest peak for the small-diameter particles A and the particle diameter dB at the highest peak for the large-diameter particles β satisfies formula (A1), which will be described later herein.

For a photoreceptor according to a second exemplary embodiment, the inorganic oxide particles include inorganic oxide particles α having an average particle diameter of 20 nm or more and 50 nm or less and inorganic oxide particles β having an average particle diameter of 80 nm or more and 400 nm or less, and the relationship between the average particle diameter da of the inorganic oxide particles α and the average particle diameter dβ of the inorganic oxide particles β satisfies formula (α1), which will be described later herein.

Configured as described above, the photoreceptors according to these exemplary embodiments may offer improved break resistance of the inorganic protective layer. A possible reason is as follows.

In the related art, there is known, in the field of electrophotographic photoreceptors having an inorganic protective layer, a technology for reducing the breakage of the inorganic protective layer caused by a mechanical load, in which inorganic oxide particles (e.g., silica particles) are incorporated into the photosensitive layer to improve the hardness of the photosensitive layer.

Because inorganic oxide particles of a single size are incorporated into the photosensitive layer, however, there is a mathematical limitation on the loading (i.e., the quantity incorporated) of the inorganic oxide particles. Consequently, there is an upper limit to the quantity of inorganic oxide particles that can be incorporated into the photosensitive layer.

In addition, it is generally known that the hardness of the photosensitive layer improves with increasing loading of the inorganic oxide particles.

For this reason, there is an upper limit to the hardness of the photosensitive layer, too, due to the upper limit to the loading of the inorganic oxide particles.

Further improving the break resistance of the inorganic protective layer, however, requires an increase in the hardness of the photosensitive layer.

To address this, in the first exemplary embodiment, the inorganic oxide particles are incorporated into the photosensitive layer in such a manner that formula (A1) will be satisfied. As a result of this, a state may arise in which the small-diameter particles A are distributed in the gaps between the large-diameter particles B, and a higher loading of the inorganic oxide particles may be achieved compared with when inorganic oxide particles of a single size are used. In consequence, an increase in the hardness of the photosensitive layer may also be achieved, and the break resistance of the inorganic protective layer may improve.

In the second exemplary embodiment, on the other hand, the inorganic oxide particles are incorporated into the photosensitive layer in such a manner that formula (α1) will be satisfied. As a result of this, a state may arise in which the inorganic oxide particles α are distributed in the gaps between the inorganic oxide particles 3, and a higher loading of the inorganic oxide particles may be achieved compared with when inorganic oxide particles of a single size are used. In consequence, an increase in the hardness of the photosensitive layer may also be achieved, and the break resistance of the inorganic protective layer may improve.

Presumably for this reason, the photoreceptors according to these exemplary embodiments may offer improved break resistance of the inorganic protective layer.

The details of a photoreceptor that falls under both of the first and second exemplary embodiments will now be described. A photoreceptor according to an aspect of the present disclosure, however, only needs to be a photoreceptor that falls under one of the first or second exemplary embodiment.

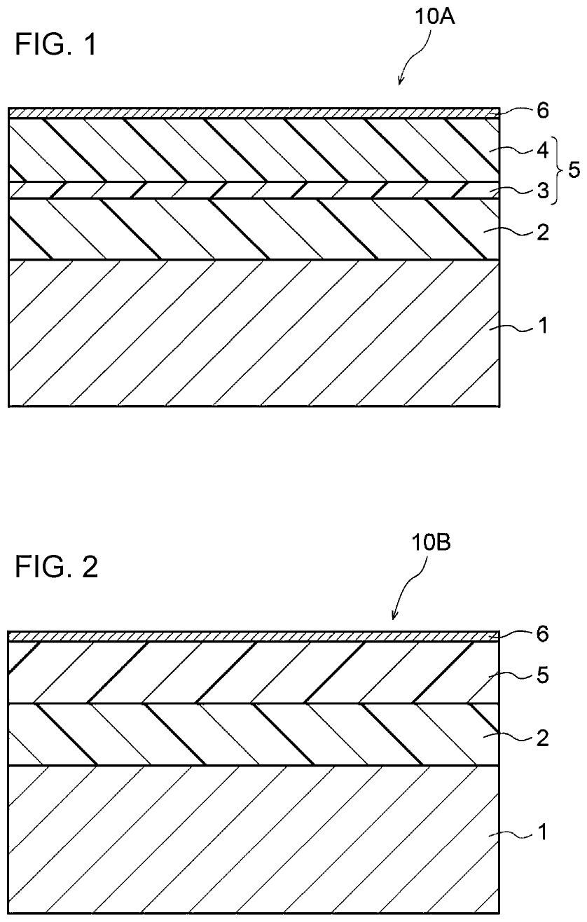

FIG. 1 is a partial cross-sectional view schematically illustrating an example of a layer structure of a photoreceptor according to an exemplary embodiment. The photoreceptor 10A illustrated in FIG. 1 has a multilayer photosensitive layer. The photoreceptor 10A has a structure in which an undercoat layer 2, a charge-generating layer 3, a charge transport layer 4, and an inorganic protective layer 6 are stacked in this order on a conductive substrate 1, and the charge-generating layer 3 and the charge transport layer 4 form a photosensitive layer 5 (so-called a functionally separated photosensitive layer). The photoreceptor 10A may have an intermediate layer (not illustrated) between the undercoat layer 2 and the charge-generating layer 3. The presence of the undercoat layer 2 is optional.

FIG. 2 is a partial cross-sectional view schematically illustrating another example of a layer structure of a photoreceptor according to this exemplary embodiment. The photoreceptor 10B illustrated in FIG. 2 has a single-layer photosensitive layer. The photoreceptor 10B has a structure in which an undercoat layer 2, a photosensitive layer 5, and an inorganic protective layer 6 are stacked in this order on a conductive substrate 1. The photoreceptor 10B may have an intermediate layer (not illustrated) between the undercoat layer 2 and the photosensitive layer 5. The presence of the undercoat layer 2 is optional.

When the photosensitive layer of the photoreceptor according to this exemplary embodiment is a multilayer photosensitive layer composed of a charge-generating layer and a charge transport layer, the inorganic protective layer is disposed on and in contact with the charge transport layer. The inorganic oxide particles, furthermore, are not contained in the charge-generating layer but are contained in the charge transport layer.

When the photosensitive layer of the photoreceptor according to this exemplary embodiment is a single-layer photosensitive layer, on the other hand, the inorganic oxide particles are contained in the single-layer photosensitive layer.

In other words, the inorganic oxide particles are contained in the layer of the photosensitive layer that is in contact with the inorganic protective layer.

When matters common to a multilayer photosensitive layer and a single-layer photosensitive layer are described in this exemplary embodiment, the description is given using a more generic term, “photosensitive layer.”

Particle Size Distribution of the Inorganic Oxide Particles Obtained through Cross-Sectional Observation of the Photosensitive Layer

In a particle size distribution of the inorganic oxide particles obtained through cross-sectional observation of the photosensitive layer, particles on the small-diameter side are defined as small-diameter particles A, and particles on the large-diameter side are defined as large-diameter particles B, with the threshold particle diameter being 60 nm.

The highest peak for the small-diameter particles A is present in the range of 20 nm to 50 nm.

The highest peak for the large-diameter particles β is present in the range of 80 nm to 400 nm.

The relationship between the particle diameter dA at the highest peak for the small-diameter particles A and the particle diameter dB at the highest peak for the large-diameter particles B, furthermore, satisfies formula (A1) below.

By virtue of this relationship satisfying formula (A1) below, the hardness of the photosensitive layer (specifically, the charge transport layer or single-layer photosensitive layer) may increase, and the break resistance of the inorganic protective layer may improve.

For the improvement of the break resistance of the inorganic protective layer, the relationship may satisfy formula (A2) below; preferably, the relationship satisfies formula (A3) below.

$$dB / dA \geq 4. \qquad ( A1 )$$

$$dB / dA \geq 6. \qquad ( A2 )$$

$$dB / dA \geq 7.0 \qquad ( A3 )$$

For the improvement of the break resistance of the inorganic protective layer, the highest peak for the small-diameter particles A may be present in the range of 20 nm to 50 nm, and the highest peak for the large-diameter particles β may be present in the range of 80 nm to 400 nm.

The upper limit to “dB/dA,” furthermore, may be 20.0 or less because a large difference in particle diameter may lead to a greater number of small-diameter particles required to achieve the form in which the small-diameter particles fill the gaps between the large-diameter particles, and the resulting increase in the total area of particle-to-particle interfaces may heighten the risk of fractures due to displacement at particle-to-particle interfaces; preferably, the upper limit is 15.0 or less.

In addition, the particle size distribution of the small-diameter particles A and that of the large-diameter particles β may be unimodal distributions. In other words, in the particle size distribution of the inorganic oxide particles, there may be one peak for the small-diameter particles A and one peak for the large-diameter particles B.

Percentage Areas of the Inorganic Oxide Particles Obtained through Cross-Sectional Observation of the Photosensitive Layer

For percentage areas of the inorganic oxide particles obtained through cross-sectional observation of the photosensitive layer, the relationship between the percentage area VA of the small-diameter particles A and the percentage area VB of the large-diameter particles β may satisfy formula (B1) below.

When this relationship satisfies formula (B1) below, a state may arise in which the small-diameter particles A have sufficiently entered the gaps between the large-diameter particles B. As a result of this, the hardness of the photosensitive layer (specifically, the charge transport layer or single-layer photosensitive layer) may increase, and the break resistance of the inorganic protective layer may improve.

The relationship may satisfy formula (B2) below, preferably formula (B3) below.

$$VB / ( VA + VB ) \times 100 \geq 60 \% \qquad ( B1 )$$

$$VB / ( VA + VB ) \times 100 \geq 65 \% \qquad ( B2 )$$

$$VB / ( VA + VB ) \times 100 \geq 70 \% \qquad ( B3 )$$

The upper limit to “VB/(VA+VB),” however, may be 85% or less because without a sufficient quantity, the small-diameter particles may fail to fill the gaps between the large-diameter particles, and the improvement in strength may be less effective; preferably, the upper limit is 80% or less.

The percentage area of the inorganic oxide particles obtained through cross-sectional observation of the photosensitive layer (i.e., the percentage area of all inorganic oxide particles (VA+VB)) may be 50% or more and 90% or less, preferably 55% or more and 85% or less, more preferably 60% or more and 80% or less.

When the percentage area of the inorganic oxide particles falls within these ranges, a state may arise in which the inside of the photosensitive layer (specifically, the charge transport layer or single-layer photosensitive layer) has been sufficiently filled with the inorganic oxide particles. As a result of this, the hardness of the photosensitive layer (specifically, the charge transport layer or single-layer photosensitive layer) may increase, and the break resistance of the inorganic protective layer may improve.

The percentage areas of the small-diameter particles A, the large-diameter particles B, and the inorganic oxide particles are percentage areas in relation to the layer of the photosensitive layer that is in contact with the inorganic protective layer (i.e., the charge transport layer or single-layer photosensitive layer, containing the inorganic oxide particles). Method for the Cross-Sectional Observation of the Photosensitive Layer

The method for the cross-sectional observation of the photosensitive layer is as follows.

The photosensitive layer of the photoreceptor is cut in the direction along its thickness, for example with a knife, to yield a sample with the exposed cross-section as the surface for observation.

Then the surface for observation of the sample is observed using a scanning electron microscope (SEM), through which a cross-sectional SEM image of the photosensitive layer is obtained.

Subsequently, using the cross-sectional SEM image of the photosensitive layer, the particle size distribution of the inorganic oxide particles is obtained. Specifically, the inorganic oxide particles are observed, and the images of the observed inorganic oxide particles are analyzed using WinROOF image processing and analysis software (manufactured by Mitani Corporation), through which the equivalent circular diameter of at least 200 particles is determined. Then, based on the equivalent circular diameters determined, the particle size distribution of the inorganic oxide particles is obtained.

Separately, using the cross-sectional SEM image of the photosensitive layer, the percentage areas of the small-diameter particles A, the large-diameter particles B, and the inorganic oxide particles are also determined. Specifically, the inorganic oxide particles are observed, and the images of the observed inorganic oxide particles are analyzed using WinROOF image processing and analysis software (manufactured by Mitani Corporation), through which the percentage area of all observed inorganic oxide particles in relation to the layer of the photosensitive layer that is in contact with the inorganic protective layer (i.e., the charge transport layer or single-layer photosensitive layer, containing the inorganic oxide particles) is determined.

Additionally, in the measurement of the percentage area of all inorganic oxide particles, the percentage area of the small-diameter particles A, having a diameter (i.e., equivalent circular diameter) of 60 nm or less, and the percentage area of the large-diameter particles B, having a diameter (i.e., equivalent circular diameter) exceeding 60 nm, are also determined.

### Composition of the Inorganic Oxide Particles

Examples of inorganic oxide particles include silica particles, alumina particles, and titanium oxide particles.

Of these, the inorganic oxide particles may be silica particles in particular, for the reduction of decreases in the electrical properties of the photoreceptor.

Examples of silica particles include dry silica particles and wet silica particles.

Examples of dry silica particles include pyrogenic silica (fumed silica), which is obtained by burning a silane compound, and VMC (vaporized metal combustion) silica, which is obtained by explosively burning a metal silicon powder.

Examples of wet silica particles include wet silica particles obtained through a neutralization reaction between sodium silicate and a mineral acid (precipitated silica, synthesized and aggregated under alkaline conditions, and silica gel particles, synthesized and aggregated under acidic conditions), colloidal silica particles (silica sol particles), which are obtained by making an acidic silicic acid alkaline and polymerizing it, and sol-gel silica particles, which are obtained through the hydrolysis of an organic silane compound (e.g., an alkoxysilane).

The silica particles may be pyrogenic silica (fumed silica), which has few surface silanol groups and has a scarcity of pore structures, for the reduction of image defects caused by degraded electrical properties.

The inorganic oxide particles may have their surface treated with a hydrophobizing agent for dispersibility in the coating solution for layer formation. Examples of hydrophobizing agents include known silane compounds, such as chlorosilane, alkoxysilanes, and silazane.

The hydrophobizing agent may be a silane compound having a trimethylsilyl group, decylsilyl group, or phenylsilyl group. In other words, the silica particles may have trimethylsilyl, decylsilyl, or phenylsilyl groups on their surface.

Examples of silane compounds having a trimethylsilyl group include trimethylchlorosilane, trimethylmethoxysilane, and 1,1,1,3,3,3-hexamethyldisilazane. Examples of silane compounds having a decylsilyl group include decyltrichlorosilane, decyldimethylchlorosilane, and decyltrimethoxysilane. Examples of silane compounds having a phenyl group include triphenylmethoxysilane and triphenylchlorosilane.

As the inorganic oxide particles, inorganic oxide particles including, for example, inorganic oxide particles α having an average particle diameter of 20 nm or more and 50 nm or less and inorganic oxide particles β having an average particle diameter of 80 nm or more and 400 nm or less are used to ensure that formula (A1) will be satisfied.

The relationship between the average particle diameter da of the inorganic oxide particles α and the average particle diameter dβ of the inorganic oxide particles β, furthermore, satisfies formula (α1) below, for example. This relationship may satisfy formula (α2) below, preferably formula (α3) below.

$$d β / d α \geq 4. \qquad ( α1 )$$

$$d β / d α \geq 6. \qquad ( α2 )$$

$$d β / d α \geq 7. \qquad ( α3 )$$

Moreover, when it is intended that formula (B1) will be satisfied and that percentage areas of the inorganic oxide particles as specified above will be achieved, the quantities of the inorganic oxide particles α and the inorganic oxide particles J, having average particle diameters as specified above, are adjusted.

The average particle diameters of the inorganic oxide particles α and the inorganic oxide particles β are measured as follows.

The inorganic oxide particles of interest are observed with a scanning electron microscope, the equivalent circular diameter of 100 randomly selected primary particles is determined, and a value obtained by arithmetically averaging the equivalent circular diameters is reported as the average particle diameter.

Each layer of the photoreceptor will now be described in detail.

### Conductive Substrate

Examples of conductive substrates include a metal plate, a metal drum, and a metal belt containing a metal (e.g., aluminum, copper, zinc, chromium, nickel, molybdenum, vanadium, indium, gold, or platinum) or an alloy (e.g., stainless steel). A sheet of paper, a resin film, and a belt coated, by application or deposition, or laminated with a conductive compound (e.g., a conductive polymer or indium oxide), a metal (e.g., aluminum, palladium, or gold), or an alloy are also examples of conductive substrates. In this context, “conductive” means that the volume resistivity is less than 1×10¹³ Ω·cm.

When the electrophotographic photoreceptor is used with a laser printer, the surface of the conductive substrate may have been roughened to a centerline average roughness Ra of 0.04 μm or more or 0.5 μm or less for the purpose of reducing interference fringes that occur upon irradiation with laser light. When the light source used is incoherent light, surface roughening to prevent interference fringes is not particularly needed; however, performing surface roughening may be more suitable for extending the service life because it may reduce the occurrence of defects caused by irregularities in the surface of the conductive substrate.

Examples of methods for surface roughening include wet honing, which is performed by suspending an abrasive in water and spraying the resulting suspension onto the conductive substrate, centerless grinding, in which the conductive substrate is pressed against a rotating grindstone for continuous grinding work, and anodization treatment.

The method of dispersing a conductive or semiconducting powder in a resin to form a layer on the surface of the conductive substrate and creating a rough surface with the particles dispersed in the layer, rather than roughening the surface of the conductive substrate, is also an example of a method for surface roughening.

Surface roughening treatment by anodization is a treatment in which a conductive substrate made of a metal (e.g., made of aluminum) as an anode is oxidized in an electrolyte solution to form an oxide film on the surface of the conductive substrate. Examples of electrolyte solutions include a sulfuric acid solution and an oxalic acid solution. The porous anodic oxide film formed through anodization, however, is chemically active, prone to contamination, and exhibits great changes in resistance depending on the environment in its freshly formed state. To address this, sealing treatment may be performed, in which fine pores in the oxide film are sealed utilizing volume expansion caused by hydration reaction in pressurized steam or boiling water (optionally with an added metal salt, for example of nickel) to convert the oxide into a more stable hydrated oxide.

The thickness of the anodic oxide film may be, for example, 0.3 μm or more or 15 m or less. When this thickness falls within this range, barrier properties against injection may tend to be expressed, and the increase in residual potential caused by repeated use may tend to be limited.

The conductive substrate may be subjected to treatment with an acidic treatment solution or boehmite treatment.

The treatment with an acidic treatment solution is conducted, for example, as follows. First, an acidic treatment solution containing phosphoric acid, chromic acid, and hydrofluoric acid is prepared. The blending percentages of phosphoric acid, chromic acid, and hydrofluoric acid in the acidic treatment solution may be in the ranges of, for example, 10% by mass to 11% by mass for phosphoric acid, 3% by mass to 5% by mass for chromic acid, and 0.5% by mass to 2% by mass for hydrofluoric acid, and the overall concentration of these acids may be in the range of 13.5% by mass to 18% by mass. The treatment temperature may be, for example, 42° C. or above and 48° C. or below. The thickness of the coating may be 0.3 μm or more and 15 μm or less.

The boehmite treatment is performed through, for example, immersion in purified water at 90° C. or above or 100° C. or below for 5 μminutes to 60 μminutes or by exposing the substrate to heated steam at 90° C. or above or 120° C. or below for 5 μminutes to 60 μminutes. The thickness of the coating may be 0.1 μm or more and 5 μm or less. This coating may further be subjected to anodization treatment using an electrolyte solution with low solubility to the coating, such as a solution of adipic acid, boric acid, a borate, a phosphate, a phthalate, a maleate, a benzoate, a tartrate, or a citrate.

### Undercoat Layer

The undercoat layer is, for example, a layer containing inorganic particles and at least one binder resin.

An example of inorganic particles is inorganic particles having a powder resistance (volume resistivity) of 1×10² Ω·cm or more or 1×10¹¹ Ω·cm or less.

Of such particles, the inorganic particles having such a resistance value may be, for example, metal oxide particles in particular, such as tin oxide particles, titanium oxide particles, zinc oxide particles, or zirconium oxide particles, and zinc oxide particles are preferred.

The specific surface area of the inorganic particles as measured by the BET method may be, for example, 10 μm²/g or more.

The volume-average diameter of the inorganic particles may be, for example, 50 nm or more and 2000 nm or less (preferably, 60 nm or more and 1000 nm or less).

The quantity of the inorganic particles may be, for example, 10% by mass or more and 80% by mass or less, preferably 40% by mass or more and 80% by mass or less, in relation to the binder resin.

The inorganic particles may have been subjected to surface treatment. As the inorganic particles, a mixture of two or more types with different surface treatments or different diameters may be used.

As for the surface treatment agent, examples include a silane coupling agent, a titanate coupling agent, an aluminum coupling agent, and a surfactant. A silane coupling agent may be used in particular, and a silane coupling agent having an amino group is preferred.

Examples of silane coupling agents having an amino group include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

A mixture of two or more silane coupling agents may also be used. For example, a silane coupling agent having an amino group and a different silane coupling agent may be used in combination. Examples for this different silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The method for the surface treatment with a surface treatment agent may be any method as long as it is a known method and may be any of a dry method or wet method.

The amount of the surface treatment agent used for the treatment may be, for example, 0.5% by mass or more and 10% by mass or less in relation to the inorganic particles.

The undercoat layer may contain an electron-accepting compound (acceptor compound) together with the inorganic particles because it may enhance the long-term stability of electrical properties and improve carrier-blocking properties.

Examples of electron-accepting compounds include electron-transporting substances, such as quinone compounds, e.g., chloranil and bromanil; tetracyanoquinodimethane compounds; fluorenone compounds, e.g., 2,4,7-trinitrofluorenone and 2,4,5,7-tetranitro-9-fluorenone; oxadiazole compounds, e.g., 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone compounds; thiophene compounds; diphenoquinone compounds, e.g., 3,3′,5,5′-tetra-t-butyldiphenoquinone; and benzophenone compounds.

The electron-accepting compound may be a compound having an anthraquinone structure in particular. Examples of compounds having an anthraquinone structure include hydroxyanthraquinone compounds, aminoanthraquinone compounds, and aminohydroxyanthraquinone compounds, with specific examples including anthraquinone, alizarin, quinizarin, anthrarufin, and purpurin.

In the undercoat layer, the electron-accepting compound may be contained dispersed together with the inorganic particles or may be contained in a state in which it has been attached to the surface of the inorganic particles.

Examples of methods for attaching the electron-accepting compound to the surface of the inorganic particles include a dry method or a wet method.

The dry method is, for example, a method in which the electron-accepting compound is attached to the surface of the inorganic particles by applying the electron-accepting compound, either directly or as a solution in an organic solvent, through dropwise addition or spraying with dry air or nitrogen gas while stirring the inorganic particles using equipment such as a mixer that produces a high shear force. When the electron-accepting compound is applied through dropwise addition or spraying, the process may be performed at a temperature equal to or lower than the boiling point of the solvent. After the dropwise addition or spraying of the electron-accepting compound, baking may additionally be performed at 100° C. or above. The baking temperature and the duration of baking are not particularly restricted as long as electrophotographic properties are obtained.

The wet method is, for example, a method in which the electron-accepting compound is attached to the surface of the inorganic particles by adding the electron-accepting compound while dispersing the inorganic particles in a solvent using equipment such as an agitator, sonicator, sand mill, attritor, or ball mill, stirring the mixture or dispersing the compound, and then removing the solvent. As for the method for solvent removal, the solvent is removed by, for example, filtration or distillation. After the solvent removal, baking may additionally be performed at 100° C. or above. The baking temperature and the duration of baking are not particularly limited as long as electrophotographic properties are obtained. In the wet method, water contained in the inorganic particles may be removed before the addition of the electron-accepting compound, and examples for it include the method of removing the water during stirring and heating in a solvent and the method of removing the water through azeotropic boiling with a solvent.

The attachment of the electron-accepting compound may be performed before or after subjecting the inorganic particles to surface treatment with a surface treatment agent, or the attachment of the electron-accepting compound and the surface treatment with a surface treatment agent may be performed simultaneously.

The amount of the electron-accepting compound may be, for example, 0.01% by mass or more and 20% by mass or less, preferably 0.01% by mass or more and 10% by mass or less, in relation to the inorganic particles.

Examples of binder resins used in the undercoat layer include known materials, such as known polymeric compounds, including acetal resins (e.g., polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenolic resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and silane coupling agents.

Resins such as electron-transporting resins, which have an electron-transporting group, and conductive resins (e.g., polyanilines) are also examples of binder resins used in the undercoat layer.

Of these, the binder resin used in the undercoat layer may be, in particular, a resin insoluble in the solvent that is applied when the upper layer is formed, preferably a thermosetting resin, such as a urea resin, phenolic resin, phenol-formaldehyde resin, melamine resin, urethane resin, unsaturated polyester resin, alkyd resin, or epoxy resin; or a resin obtained through the reaction between a curing agent and at least one resin selected from the group consisting of a polyamide resin, a polyester resin, a polyether resin, a methacrylic resin, an acrylic resin, a polyvinyl alcohol resin, and a polyvinyl acetal resin.

When two or more of such binder resins are used in combination, their mixing percentages are selected as appropriate.

In the undercoat layer, various additives may be contained for the improvement of electrical properties, the improvement of environmental stability, and the improvement of image quality.

Examples of additives include known materials, such as electron-transporting pigments, e.g., condensed polycyclic and azo pigments, zirconium chelate compounds, titanium chelate compounds, aluminum chelate compounds, titanium alkoxide compounds, organic titanium compounds, and silane coupling agents. As mentioned above, silane coupling agents are used for surface treatment of the inorganic particles; however, they may also be added to the undercoat layer as additives.

Examples of silane coupling agents as additives include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of zirconium chelate compounds include zirconium butoxide, zirconium ethylacetoacetate, zirconium triethanolamine, acetylacetonate zirconium butoxide, ethylacetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of titanium chelate compounds include tetraisopropyl titanate, tetra-normal-butyl titanate, the butyl titanate dimer, tetra(2-ethylhexyl) titanate, titanium acetylacetonate, polytitanium acetylacetonate, titanium octylene glycolate, the titanium lactate ammonium salt, titanium lactate, the titanium lactate ethyl ester, titanium triethanolaminate, and polyhydroxytitanium stearate.

Examples of aluminum chelate compounds include aluminum isopropylate, monobutoxyaluminum diisopropylate, aluminum butyrate, diethylacetoacetate aluminum diisopropylate, and aluminum tris(ethylacetoacetate).

Such additives may be used individually or as a mixture or polycondensate of multiple compounds.

The undercoat layer may have a Vickers hardness of 35 or greater.

The surface roughness (ten-point height of roughness profile) of the undercoat layer may have been adjusted, for the reduction of moiré fringes, to fall within the range of 1/(4n) (where n is the refractive index of the upper layer) to ½ of the wavelength λ of the laser for exposure used.

Resin particles, for example, may be incorporated into the undercoat layer for the adjustment of surface roughness. Examples of resin particles include silicone resin particles and crosslinked polymethyl methacrylate resin particles. The surface of the undercoat layer, furthermore, may be polished for the adjustment of surface roughness. Examples of polishing methods include buff polishing, sandblasting treatment, wet honing, and grinding treatment.

In the formation of the undercoat layer, there is no specific restriction, and known formation methods are utilized; however, for example, the process is performed by forming a coating of a coating solution for undercoat layer formation, which is obtained by adding the ingredients described above to a solvent, drying this coating, and optionally heating the dried coating.

Examples of solvents for preparing the coating solution for undercoat layer formation include known organic solvents, such as alcohol solvents, aromatic hydrocarbon solvents, halogenated hydrocarbon solvents, ketone solvents, ketone alcohol solvents, ether solvents, and ester solvents.

Specific examples of such solvents include common organic solvents, such as methanol, ethanol, n-propanol, isopropanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of methods for dispersing the inorganic particles in preparing the coating solution for undercoat layer formation include known methods, such as a roller mill, a ball mill, a vibration ball mill, an attritor, a sand mill, a colloid mill, and a paint shaker.

Examples of methods for applying the coating solution for undercoat layer formation onto the conductive substrate include common methods, such as blade coating, wire bar coating, spray coating, dip coating, bead coating, air knife coating, and curtain coating.

The thickness of the undercoat layer may be set within the range of 15 μm or more, preferably 20 μm to 50 μm.

### Intermediate Layer

The intermediate layer is, for example, a layer containing at least one resin. Examples of resins used in the intermediate layer include polymeric compounds such as acetal resins (e.g., polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer containing at least one organometallic compound. Examples of organometallic compounds used in the intermediate layer include organometallic compounds containing a metal atom of, for example, zirconium, titanium, aluminum, manganese, or silicon.

Such compounds used in the intermediate layer may be used individually or as a mixture or polycondensate of multiple compounds.

Of these, the intermediate layer may be, in particular, a layer containing an organometallic compound containing a zirconium atom or silicon atom.

In the formation of the intermediate layer, there is no specific restriction, and known formation methods are utilized; however, for example, the process is performed by forming a coating of a coating solution for intermediate layer formation, which is obtained by adding the ingredients described above to a solvent, drying this coating, and optionally heating the dried coating.

As the coating method by which the intermediate layer is formed, common methods, such as dip coating, push coating, wire bar coating, spray coating, blade coating, air knife coating, and curtain coating, are used.

The thickness of the intermediate layer may be set within the range of 0.1 μm to 3 km. It is possible to use the intermediate layer as the undercoat layer.

### Charge-Generating Layer

The charge-generating layer is, for example, a layer containing a charge-generating material and at least one binder resin. The charge-generating layer, furthermore, may be a deposited layer of a charge-generating material. The deposited layer of a charge-generating material may be employed when an incoherent light source, such as an LED (light-emitting diode) or organic EL (electroluminescence) image array, is used.

Examples of charge-generating materials include azo pigments, such as bisazo and trisazo pigments; annulated aromatic pigments, such as dibromoanthanthrone; perylene pigments; pyrrolopyrrole pigments; phthalocyanine pigments; zinc oxide; and trigonal selenium.

Of these, the charge-generating material may be a metal phthalocyanine pigment or non-metal phthalocyanine pigment in particular, if response to exposure to laser light in the near-infrared range is intended. Specifically, the charge-generating material may be, for example, hydroxygallium phthalocyanine; chlorogallium phthalocyanine; dichlorotin phthalocyanine; or titanyl phthalocyanine.

If response to exposure to laser light in the near-ultraviolet range is intended, on the other hand, the charge-generating material may be, for example, an annulated aromatic pigment, such as dibromoanthanthrone; a thioindigo pigment; a porphyrazine compound; zinc oxide; trigonal selenium; or a bisazo pigment.

Such charge-generating materials as listed above may be used even when an LED, organic EL image array, or other incoherent light source having its center wavelength of emission within the range of 450 nm to 780 nm is employed.

When an n-type semiconductor, such as an annulated aromatic pigment, perylene pigment, or azo pigment, is used as the charge-generating material, by contrast, the charge-generating material does not easily produce dark current, and the image defect called black spots may be limited even when the photosensitive layer is formed as a thin film. As for the determination of whether the charge-generating material is n-type, it is determined based on the polarity of the photocurrent that flows through it using the commonly employed time-of-flight method; materials that allow electrons to flow as a carrier more easily than holes are considered n-type.

The binder resin used in the charge-generating layer is selected from a wide variety of insulating resins, and, furthermore, the binder resin may be selected from organic photoconductive polymers, such as poly-N-vinylcarbazole, polyvinylanthracene, polyvinylpyrene, and polysilanes.

Examples of binder resins include polyvinyl butyral resins, polyarylate resins (e.g., polycondensates of a bisphenol and an aromatic dicarboxylic acid), polycarbonate resins, polyester resins, phenoxy resins, vinyl chloride-vinyl acetate copolymers, polyamide resins, acrylic resins, polyacrylamide resins, polyvinylpyridine resins, cellulose resins, urethane resins, epoxy resins, casein, polyvinyl alcohol resins, and polyvinylpyrrolidone resins. In this context, “insulating” means that the volume resistivity is 10¹³ Ω·cm or more. One such binder resin alone or a mixture of two or more are used.

The blending ratio between the charge-generating material and the binder resin may be in the range of 10:1 to 1:10 as a ratio by mass.

In the charge-generating layer, known additives may also be contained.

In the formation of the charge-generating layer, there is no specific restriction, and known formation methods are utilized; however, for example, the process is performed by forming a coating of a coating solution for charge-generating layer formation, which is obtained by adding the ingredients described above to at least one solvent, drying this coating, and optionally heating the dried coating. The formation of the charge-generating layer may be performed through the deposition of the charge-generating material. The formation of the charge-generating layer through deposition may be employed particularly when the charge-generating material used is an annulated aromatic pigment or perylene pigment.

Examples of solvents for preparing the coating solution for charge-generating layer formation include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. One such solvent alone or a mixture of two or more are used.

The method for dispersing particles (e.g., the charge-generating material) in the coating solution for charge-generating layer formation is, for example, by the use of a medium disperser, such as a ball mill, vibration ball mill, attritor, sand mill, or horizontal sand mill, or a mediumless disperser, such as an agitator, sonicator, roller mill, or high-pressure homogenizer. Examples of high-pressure homogenizers include an impact homogenizer, which disperses the particles by causing liquid-liquid collisions or liquid-wall collisions of a dispersion in a high-pressure state, or a microfluidic homogenizer, which disperses the particles by forcing a fluid through a microchannel in a high-pressure state. During the dispersion process, the average particle diameter of the charge-generating material in the coating solution for charge-generating layer formation may be reduced to 0.5 μm or less, preferably 0.3 μm or less, more preferably 0.15 μm or less.

Examples of methods for applying the coating solution for charge-generating layer formation onto the undercoat layer (or onto the intermediate layer) include common methods, such as blade coating, wire bar coating, spray coating, dip coating, bead coating, air knife coating, and curtain coating.

The thickness of the charge-generating layer may be set within the range of 0.1 μm to 5.0 μm, preferably 0.2 μm to 2.0 μm.

### Charge Transport Layer

The charge transport layer is, for example, a layer containing at least one binder resin, at least one charge transport material, and the inorganic oxide particles. The charge transport layer may be a layer containing a polymeric charge transport material.

Examples of charge transport materials include electron-transporting compounds, such as quinone compounds, e.g., p-benzoquinone, chloranil, bromanil, and anthraquinone; tetracyanoquinodimethane compounds; fluorenone compounds, e.g., 2,4,7-trinitrofluorenone; xanthone compounds; benzophenone compounds; cyanovinyl compounds; and ethylene compounds. Hole-transporting compounds, such as triarylamine compounds, benzidine compounds, arylalkane compounds, aryl-substituted ethylene compounds, stilbene compounds, anthracene compounds, and hydrazone compounds, are also examples of charge transport materials. One such charge transport material alone or two or more are used, but charge transport materials that can be used are not limited to these.

As the charge transport material, triarylamine derivatives indicated by structural formula (a-1) below and benzidine derivatives indicated by structural formula (α-2) below may be used for charge mobility reasons.

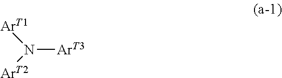

In structural formula (a−1), Ar^{T1}, Ar^{T2}, and Ar^{T3} each independently indicate a substituted or unsubstituted aryl group, —C₆H₄—C(R^{T4})═C(R^{T5})(R^{T6}) or —C₆H₄—CH═CH—CH═C(R^{T7})(R^{T8}). R^{T4}, R^{T5}, R^{T6}, R^{T7}, and R^{T8} each independently indicate a hydrogen atom, a substituted or unsubstituted alkyl group, or a substituted or unsubstituted aryl group.

Examples of substituents for each of the above groups include a halogen atom, a C1 to C5 alkyl group, and a C1 to C5 alkoxy group. A substituted amino group substituted with one or more C1 to C3 alkyl groups is also an example of a substituent for each of the above groups.

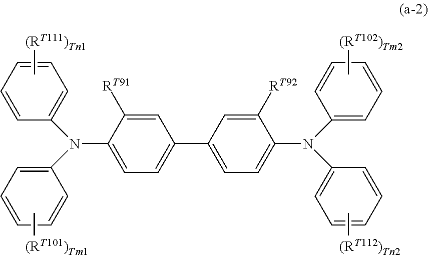

In structural formula (a-2), R^{T91} and R^{T92} each independently indicate a hydrogen atom, a halogen atom, a C1 to C5 alkyl group, or a C1 to C5 alkoxy group. R^{T101}, R^{T102}, R^{T111}, and R^{T112} each independently indicate a halogen atom, a C1 to C5 alkyl group, a C1 to C5 alkoxy group, an amino group substituted with one or more C1 or C2 alkyl groups, a substituted or unsubstituted aryl group, —C(R^{T12})═C(R^{T13})(R^{T14}) or —CH═CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently indicate an integer of 0 or greater and 2 or less.

Examples of substituents for each of the above groups include a halogen atom, a C1 to C5 alkyl group, and a C1 to C5 alkoxy group. A substituted amino group substituted with one or more C1 to C3 alkyl groups is also an example of a substituent for each of the above groups.

Of the triarylamine derivatives indicated by structural formula (α-1) above and the benzidine derivatives indicated by structural formula (α-2) above, triarylamine derivatives having “—C₆H₄—CH═CH—CH═C(R^{T7})(R^{T8})” and benzidine derivatives having “—CH═CH—CH═C(R^{T15})(R^{T16}),” in particular, may be used for charge mobility reasons.

As the polymeric charge transport material, known polymeric materials having charge transport properties, such as poly-N-vinylcarbazole and polysilanes, are used. Polyester-based polymeric charge transport materials may be used in particular. The polymeric charge transport material may be used alone, but may also be used in combination with a binder resin.

Examples of binder resins used in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinylcarbazole, and polysilanes. Of these, the binder resin may be a polycarbonate resin or polyarylate resin in particular. One such binder resin alone or two or more are used.

The blending ratio between the charge transport material and the binder resin may be from 10:1 to 1:5 as a ratio by mass.

In the charge transport layer, known additives may also be contained.

The charge transport layer is formed through coating. An exemplary embodiment of the coating process includes, for example, preparing a coating solution for charge transport layer formation by dissolving or dispersing the binder resin, the charge transport material, and the inorganic oxide particles in at least one solvent, forming a coating film by applying the coating solution for charge transport layer formation to the surface of the charge-generating layer, and drying the coating film.

Examples of solvents for preparing the coating solution for charge transport layer formation include common organic solvents, such as aromatic hydrocarbons, e.g., benzene, toluene, xylene, and chlorobenzene; ketones, e.g., acetone and 2-butanone; halogenated aliphatic hydrocarbons, e.g., methylene chloride, chloroform, and ethylene chloride; and cyclic or linear-chain ethers, e.g., tetrahydrofuran and ethyl ether. Such solvents are used individually or as a mixture of two or more.

The method for dispersing the inorganic oxide particles in the coating solution for charge transport layer formation is, for example, by the use of a medium disperser, such as a ball mill, vibration ball mill, attritor, sand mill, or horizontal sand mill, or a mediumless disperser, such as an agitator, sonicator, roller mill, or high-pressure homogenizer.

Examples of methods for applying the coating solution for charge transport layer formation onto the charge-generating layer include common methods, such as blade coating, wire bar coating, spray coating, dip coating, bead coating, air knife coating, and curtain coating.

The thickness of the charge transport layer may be set within the range of, for example, 5 μm to 50 μm, preferably 10 μm to 30 μm.

### Inorganic Protective Layer

The inorganic protective layer is an inorganic material layer. Examples of inorganic materials include metal oxides, such as gallium oxide, aluminum oxide, zinc oxide, titanium oxide, indium oxide, tin oxide, and boron oxide; metal nitrides, such as gallium nitride, aluminum nitride, zinc nitride, titanium nitride, indium nitride, tin nitride, and boron nitride; carbon-based and silicon-based inorganic materials, such as diamond-like carbon, amorphous carbon, hydrogenated amorphous carbon, hydrogenated and fluorinated amorphous carbon, amorphous silicon carbide, hydrogenated amorphous silicon carbide, amorphous silicon, and hydrogenated amorphous silicon carbide; and mixed crystals of these materials.

The inorganic protective layer may be a layer containing at least one metal oxide for the wear resistance and electrical properties of the photoreceptor; preferably, the inorganic protective layer is a layer containing gallium oxide. The metal oxide contained in the inorganic protective layer may be one type or may be two or more.

The volume resistivity of the inorganic protective layer may be 1.0×10¹⁰ Ω·cm or more for the maintenance of the electrostatic latent image; preferably, the volume resistivity is 1.0×10¹¹ Ω·cm or more.

The method for measuring the volume resistivity of the inorganic protective layer is as follows.

The inorganic protective layer is removed from the photoreceptor and used as a sample. The sample is sandwiched between the electrodes of the sample holder of an impedance analyzer (TOYO Corporation), the resistance value is measured at an AC voltage of 1 V and a frequency of 100 Hz, and the volume resistivity is calculated based on the area of the electrodes and the thickness of the sample.

Examples of methods for forming the inorganic protective layer include known vapor-phase film formation methods, such as plasma CVD (chemical vapor deposition), metal organic chemical vapor deposition, molecular beam epitaxy, vapor deposition, and sputtering. For example, the film formation system and film formation conditions for plasma CVD described in Japanese Unexamined Patent Application Publication No. 2014-191179 can be used to form the inorganic protective layer.

The thickness of the inorganic protective layer may be 0.2 μm or more and 10 μm or less for the wear resistance and electrical properties of the photoreceptor; preferably, the thickness is 0.4 μm or more and 8 μm or less, more preferably 0.6 μm or more and 6 μm or less.

The thickness of each layer of the photoreceptor is the arithmetic mean of measurements obtained using an electromagnetic film thickness meter, and the measurements are taken in the middle in the direction along the axis of the photoreceptor at four points, spaced at 90° intervals in the circumferential direction.

### Single-Layer Photosensitive Layer

The single-layer photosensitive layer (charge-generating/charge transport layer) is, for example, a layer containing at least one binder resin, a charge-generating material, at least one charge transport material, and the inorganic oxide particles. The materials are the same as the materials described in relation to the charge-generating layer and the charge transport layer.

In the single-layer photosensitive layer, the amount of the charge-generating material may be 0.1% by mass or more and 10% by mass or less, preferably 0.8% by mass or more and 5% by mass or less, in relation to the total solids content. In the single-layer photosensitive layer, the amount of the charge transport material may be 5% by mass or more and 50% by mass or less in relation to the total solids content.

The single-layer photosensitive layer is formed through coating. An exemplary embodiment of the coating process includes, for example, preparing a coating solution for single-layer photosensitive layer formation by dissolving or dispersing the binder resin, the charge-generating material, the charge transport material, and the inorganic oxide particles in a solvent, forming a coating film by applying the coating solution for single-layer photosensitive layer formation to the surface of the undercoat layer or conductive substrate, and drying the coating film. The details of the methods for preparing and applying the coating solution for single-layer photosensitive layer formation are the same as those of the methods for preparing and applying the coating solution for charge transport layer formation.

The thickness of the single-layer photosensitive layer may be, for example, 5 μm or more and 50 μm or less, preferably 10 μm or more and 40 μm or less.

### Image Forming Apparatus and Process Cartridge

An image forming apparatus according to an exemplary embodiment includes an electrophotographic photoreceptor, a charging device that charges the surface of the electrophotographic photoreceptor, an electrostatic latent image forming device that forms an electrostatic latent image on the charged surface of the electrophotographic photoreceptor, a developing device that develops, using a developer containing toner, the electrostatic latent image on the surface of the electrophotographic photoreceptor to form a toner image, and a transfer device that transfers the toner image to the surface of a recording medium. As the electrophotographic photoreceptor, furthermore, an electrophotographic photoreceptor according to an exemplary embodiment is used.

The configuration of the image forming apparatus according to this exemplary embodiment can be applied to known types of image forming apparatuses, such as an apparatus that includes a fixing device that fixes a toner image transferred to the surface of a recording medium; a direct-transfer apparatus, which forms a toner image on the surface of an electrophotographic photoreceptor and transfers it directly to a recording medium; an intermediate-transfer apparatus, which forms a toner image on the surface of an electrophotographic photoreceptor, transfers it to the surface of an intermediate transfer body (first transfer), and transfers the toner image on the surface of the intermediate transfer body to the surface of a recording medium (second transfer); an apparatus that includes a cleaning device that cleans the surface of an electrophotographic photoreceptor between the transfer of a toner image and charging; an apparatus that includes a static eliminator that removes static electricity from the surface of an electrophotographic photoreceptor by irradiating the surface with antistatic light between the transfer of a toner image and charging; and an apparatus that includes an electrophotographic photoreceptor heater for increasing the temperature of an electrophotographic photoreceptor and thereby lowering relative temperatures.

In the case of an intermediate-transfer apparatus, the transfer device has a configuration in which it has, for example, an intermediate transfer body, which has a surface onto which the toner image is transferred, a first transfer device, which transfers the toner image formed on the surface of the electrophotographic photoreceptor to the surface of the intermediate transfer body (first transfer), and a second transfer device, which transfers the toner image on the surface of the intermediate transfer body to the surface of the recording medium (second transfer).

The image forming apparatus according to this exemplary embodiment may be any of a dry-development image forming apparatus or wet-development (a development method in which a liquid developer is used) image forming apparatus.

For the image forming apparatus according to this exemplary embodiment, a portion that includes the electrophotographic photoreceptor, for example, may be in a cartridge structure, which allows this portion to be detached from and attached to the image forming apparatus (or the portion may be a process cartridge). As the process cartridge, a process cartridge that includes an electrophotographic photoreceptor according to an exemplary embodiment, for example, may be used. The process cartridge may include, for example, at least one selected from the group consisting of the charging device, the electrostatic latent image forming device, the developing device, and the transfer device besides the electrophotographic photoreceptor.

An example of an image forming apparatus according to this exemplary embodiment will now be presented; the apparatus, however, is not limited to this example. Structural elements illustrated in the drawings will be described, and the remaining elements will not be described.

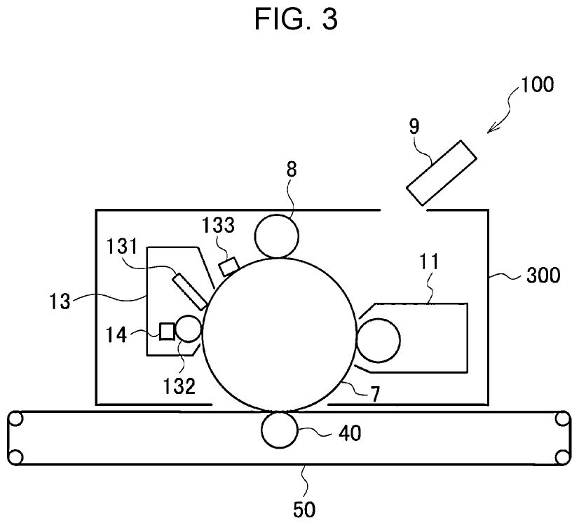

FIG. 3 is a schematic view illustrating the structure of an example of an image forming apparatus according to this exemplary embodiment.

As illustrated in FIG. 3, an image forming apparatus 100 according to this exemplary embodiment includes a process cartridge 300 that includes an electrophotographic photoreceptor 7, an exposure device 9 (an example of an electrostatic latent image forming device), a transfer device 40 (a first transfer device), and an intermediate transfer body 50. For the image forming apparatus 100, the exposure device 9 is disposed at a position at which it can illuminate the electrophotographic photoreceptor 7 with light through an opening in the process cartridge 300, the transfer device 40 is disposed at a position at which it faces the electrophotographic photoreceptor 7 with the intermediate transfer body 50 interposed therebetween, and the intermediate transfer body 50 is disposed with part of it in contact with the electrophotographic photoreceptor 7. Although not illustrated in the drawing, the apparatus also has a second transfer device, which transfers a toner image on the intermediate transfer body 50 to a recording medium (e.g., paper). The intermediate transfer body 50, the transfer device 40 (first transfer device), and the second transfer device (not illustrated) correspond to an example of a transfer device.

The process cartridge 300 in FIG. 3 holds the electrophotographic photoreceptor 7, a charging device 8 (an example of a charging device), a developing device 11 (an example of a developing device), and a cleaning device 13 (an example of a cleaning device) together inside a housing. The cleaning device 13 has a cleaning blade (an example of a cleaning member) 131, and the cleaning blade 131 is disposed to make contact with the surface of the electrophotographic photoreceptor 7. The cleaning member may be a conductive or insulating fibrous member rather than being in the form of a cleaning blade 131, and this fibrous member may be used alone or in combination with a cleaning blade 131.

In FIG. 3, an example is illustrated in which the image forming apparatus includes a fibrous member 132 (shaped like a roller) that supplies lubricant 14 to the surface of the electrophotographic photoreceptor 7 and a fibrous member 133 (shaped like a flat brush) that assists in cleaning; these components, however, are optional.

Each component of the image forming apparatus according to this exemplary embodiment will now be described.

### Charging Device

As the charging device 8, a contact charger made with a conductive or semiconducting charging roller, charging brush, charging film, charging rubber blade, or charging tube, for example, is used. Devices such as chargers known per se, including a roller charger of noncontact type and scorotron and corotron chargers, whose operation is based on corona discharge, are also used.

### Exposure Device

An example of an exposure device 9 is a piece of optical equipment that illuminates the surface of the electrophotographic photoreceptor 7 with light, such as light from a semiconductor laser, LED, or liquid crystal shutter, in the shape of a predetermined image. The wavelength of the light source is set within the spectral sensitivity range of the electrophotographic photoreceptor. In terms of the wavelength of a semiconductor laser, near-infrared lasers having their oscillation wavelength around 780 nm are the mainstream. The wavelength, however, is not limited to this; lasers with an oscillation wavelength in the 600-nm range and lasers having their oscillation wavelength in the range of 400 nm to 450 nm as blue lasers may also be utilized. If the formation of a color image is intended, furthermore, a surface-emitting laser light source of the type that can produce multiple beams may also be an option.

### Developing Device

An example of a developing device 11 is a commonly used developing device, which develops a latent image using a developer with or without contact. There is no specific restriction on the developing device 11 as long as it has the function described above; the device is selected according to the purpose. An example is a known developing unit having the function of attaching a one-component developer or two-component developer to the electrophotographic photoreceptor 7, for example using a brush or roller. A developing unit that uses a developing roller holding a developer on its surface may be employed in particular.

The developer used with the developing device 11 may be a one-component developer, which is substantially just the toner itself, or may be a two-component developer, which contains the toner and a carrier. The developer, furthermore, may be magnetic or may be nonmagnetic. As such developers, known ones are used.

### Cleaning Device

As the cleaning device 13, a device of cleaning-blade type, which includes a cleaning blade 131, is used. Besides the cleaning blade type, a fur-brush cleaning type or simultaneous development and cleaning type device may also be employed.

### Transfer Device

Examples of transfer devices 40 include transfer chargers known per se, such as contact transfer chargers, for example made with a belt, roller, film, or rubber blade, and scorotron and corotron transfer chargers, whose operation is based on corona discharge.

### Intermediate Transfer Body

As the intermediate transfer body 50, belt-shaped types (intermediate transfer belts) are used, including those made of polyimide, polyamide-imide, polycarbonate, polyarylate, polyester, and rubber, for example, with imparted semiconducting properties. In terms of the shape of the intermediate transfer body, furthermore, a drum-shaped type may also be used besides the belt-shaped type.

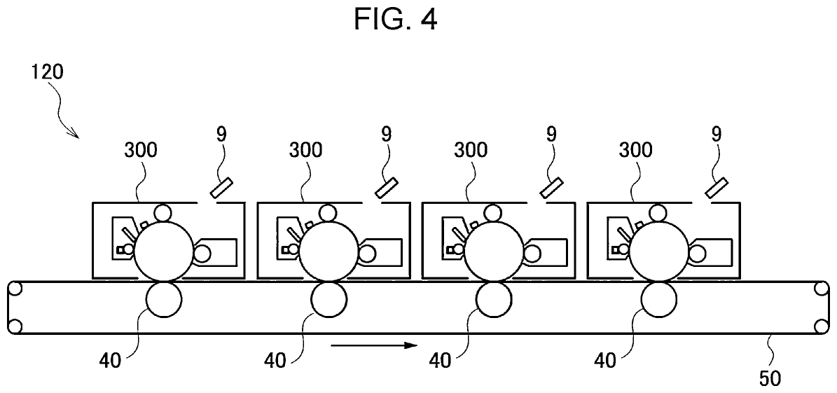

FIG. 4 is a schematic view illustrating the structure of another example of an image forming apparatus according to this exemplary embodiment.

The image forming apparatus 120 illustrated in FIG. 4 is a multicolor image forming apparatus in the tandem system equipped with four process cartridges 300. The image forming apparatus 120 has a configuration in which the four process cartridges 300 are arranged in parallel on the intermediate transfer body 50, with one electrophotographic photoreceptor used per color. Except for being in the tandem system, the image forming apparatus 120 has the same structure as the image forming apparatus 100.

### EXAMPLES

Exemplary embodiments of the disclosure will now be described in detail by examples; exemplary embodiments of the disclosure, however, are not limited to these examples.

In the following description, “parts” and “%” are by mass unless stated otherwise.

In the following description, operations such as synthesis, manufacture, treatment, and measurement are performed at room temperature (25° C.±3° C.) unless stated otherwise.

### Example 1

### Formation of an Undercoat Layer

As a conductive substrate, an aluminum cylindrical tube having an outer diameter of 30 μmm, a length of 250 μmm, and a wall thickness of 1 μmm is prepared.

One hundred parts of zinc oxide (average particle diameter, 70 nm; specific surface area, 15 μm²/g; Tayca Corporation) is mixed with 500 parts of toluene by stirring, 1.3 parts of a silane coupling agent (trade name, KBM603; Shin-Etsu Chemical Co., Ltd.; N-2-(aminoethyl)-3-aminopropyltrimethoxysilane) is added, and the resulting mixture is stirred for 2 hours. Then toluene is distilled away under reduced pressure, and baking is performed at 120° C. for 3 hours, giving zinc oxide surface-treated with a silane coupling agent.

One hundred and ten parts of the surface-treated zinc oxide is mixed with 500 parts of tetrahydrofuran by stirring, a solution obtained by dissolving 0.6 parts of alizarin in 50 parts of tetrahydrofuran is added, and the resulting mixture is stirred at 50° C. for 5 hours. Then solids are isolated by filtration under reduced pressure, and drying under reduced pressure is performed at 60° C., giving alizarin-attached zinc oxide.

One hundred parts of a solution obtained by dissolving 60 parts of the alizarin-attached zinc oxide, 13.5 parts of a curing agent (a blocked isocyanate; trade name, Sumidur 3175; Sumitomo Bayer Urethane Co., Ltd.), and 15 parts of a butyral resin (trade name, S-LEC BM-1; Sekisui Chemical Co., Ltd.) in 68 parts of methyl ethyl ketone and 5 parts of methyl ethyl ketone are mixed together, and 2 hours of dispersion is performed in a sand mill using 1-mm diameter glass beads to give a dispersion. To the dispersion are added 0.005 parts of dioctyltin dilaurate as a catalyst and 4 parts of silicone resin particles (trade name, Tospearl 145; Momentive Performance Materials Inc.), yielding a coating solution for undercoat layer formation. The coating solution for undercoat layer formation is applied to the outer circumferential surface of the conductive substrate by dip coating, and 40 μminutes of curing by drying is performed at 170° C.; in this manner, an undercoat layer having a thickness of 20 μm is formed.

### Formation of a Charge-Generating Layer

A mixture consisting of 15 parts of hydroxygallium phthalocyanine (having diffraction peaks at least at the positions of 7.5°, 9.9°, 12.5°, 16.3°, 18.6°, 25.1°, and 28.3° as Bragg angles (2θ+0.2°) in an x-ray diffraction spectrum obtained using characteristic x-rays of CuKα.) as a charge-generating material, 10 parts of a vinyl chloride-vinyl acetate copolymer resin (trade name, VMCH; manufactured by Nippon Unicar Company Limited) as a binder resin, and 200 parts of n-butyl acetate is dispersed in a sand mill using 1-mm diameter glass beads for 4 hours. The dispersion is stirred with 175 parts of n-butyl acetate and 180 parts of methyl ethyl ketone added thereto, yielding a coating solution for charge-generating layer formation. The coating solution for charge-generating layer formation is applied onto the undercoat layer by dip coating and dried at room temperature; in this manner, a charge-generating layer having a thickness of 0.25 μm is formed.

### Formation of a Charge Transport Layer

Binder resin: Polycarbonate resin (1) (viscosity-average molecular weight, 40000; The numeric values in the structural formulae indicate molar ratios (mol %).) . . . 20 parts
Charge transport material: CTM-1 . . . 15 parts
Silica particles α hydrophobized with 1,1,1,3,3,3-hexamethyldisilazane (average particle diameter dα=20 nm) . . . An amount that makes the percentage volume Vα of the silica particles α in relation to the charge transport layer the % by volume indicated in Table 1
Silica particles β hydrophobized with 1,1,1,3,3,3-hexamethyldisilazane (average particle diameter dβ=80 nm) . . . An amount that makes the percentage volume Vβ of the silica particles β in relation to the charge transport layer the % by volume indicated in Table 1
Solvent: Tetrahydrofuran (THF) . . . 600 parts

These materials are mixed together by stirring for 12 hours, giving a coating solution for charge transport layer formation. The coating solution for charge transport layer formation is applied onto the charge-generating layer by dip coating, and the coating film is dried; in this manner, a charge transport layer having a thickness of 30 μm is formed.

It should be noted that the percentage volumes specified in this section are calculated values determined from the weights of the polycarbonate resin, CTM-1, and the silica particles added as materials. Specifically, the volume of each material is calculated assuming that the density of polycarbonate resin (1) is 1.2 g/cm³, the density of CTM-1 is 1.2 g/cm³, and the density of the silica particles is 2.2 g/cm³, and the percentages of the volumes of the silica particles to the sum total of volumes is reported as the percentage volumes.

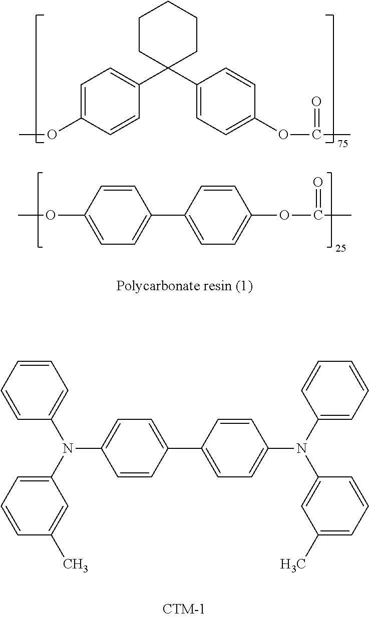

### Formation of an Inorganic Protective Layer

Using trimethylgallium as a film-forming material and employing plasma CVD, an amorphous layer containing gallium oxide is formed as an inorganic protective layer. The layer thickness is set to 1 μm.

Through these steps, a photoreceptor is obtained.

### Examples 2 to 15 and Comparative Examples 1 to 6

A photoreceptor is obtained in the same manner as in Example 1, except that the following parameters are changed. In Comparative Example 1, however, the charge transport layer is formed using one type of silica particles.
The average diameter da and percentage volume Vα of silica particles α
The average diameter dβ and percentage volume Vp of silica particles β

### Measurement of Characteristics of the Photoreceptor

In accordance with the methods already described herein, cross-sectional observation of the charge transport layer of the photoreceptor in each example or comparative example is performed, and the following characteristics are measured.
The highest peaks for small-diameter particles A and large-diameter particles β in the particle size distribution of the silica particles as the inorganic oxide particles
The percentage area of the silica particles as the inorganic oxide particles and the percentage areas of small-diameter particles A and large-diameter particles β of the silica particles

### Measurement of the Performance of the Photoreceptor

### Hardness of the Photosensitive Layer

The hardness of the surface of the photosensitive layer of the photoreceptor in each example or comparative example is measured as follows.

First, a sample is obtained, which is the photoreceptor in the example or comparative example from which the inorganic protective layer has been removed.

The hardness of the sample is Young's modulus (GPa) as determined by nanoindentation. With the axis of the photoreceptor aligned with the horizontal direction, Young's modulus is measured at the top center of the photoreceptor in the axial direction. Measurements are taken at four points spaced at 900 intervals in the direction along the circumference of the photoreceptor, and the Young's moduli at the four points are arithmetically averaged. The conditions for the measurement with the nanoindenter are as follows. The measurement results are presented in Table 1.
Tester: Trade name, HM-500; Fischer Instruments K.K.
Indenter: Diamond triangular indenter with an angle between opposite faces of 115°
Load: 75 mN

### Break Resistance of the Inorganic Protective Layer

The break resistance of the inorganic protective layer is evaluated by measuring the load at which the inorganic protective layer breaks as follows.

Measurement by a hardness test using a microhardness meter is repeated with load increments of 5 mN, starting from 0 mN. Observation with an optical microscope is performed after each load increase, and the load at which breakage occurs in the inorganic protective layer is reported as the break start load. The measurement conditions are as follows. The measurement results are presented in Table 1.
Tester: Trade name, DUH-201; Shimadzu Corporation
Indenter: Diamond spherical indenter

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Coating | Average diameter | 20 | 20 | 20 | 50 | 20 | 20 | 20 | 20 |
| solution | dα (nm) of silica | | | | | | | | |
| for | particles α | | | | | | | | |
| charge | Average diameter | 80 | 100 | 150 | 400 | 80 | 80 | 80 | 80 |
| transport | dβ(nm) of silica | | | | | | | | |
| layer | particles β | | | | | | | | |
| formation | Average diameter | 4 | 5 | 7.5 | 8 | 4.0 | 4.0 | 4.0 | 4.0 |
| | ratio (dβ/dα) | | | | | | | | |
| | Percentage volume | 15 | 21.7 | 24.42 | 19.5 | 12 | 15 | 15 | 15 |
| | Vα (%) of silica | | | | | | | | |
| | particles α | | | | | | | | |
| | Percentage volume | 45 | 40.3 | 41.58 | 30.5 | 48 | 45 | 45 | 45 |
| | Vβ(%) of silica | | | | | | | | |
| | particles β | | | | | | | | |
| | Percentage volume | 75 | 65 | 63 | 61 | 80 | 75 | 75 | 75 |
| | ratio (Vβ/(Vα + | | | | | | | | |
| | Vβ) × 100) (%) | | | | | | | | |
| | Percentage volume | 60 | 62 | 66 | 50 | 60 | 60 | 60 | 60 |
| | (Vα + Vβ) (%) | | | | | | | | |
| Charge | Particle diameter | 20 | 20 | 20 | 50 | 20 | 20 | 20 | 20 |
| transport | dA (nm) at the | | | | | | | | |
| layer | highest peak for | | | | | | | | |
| (particle | small-diameter | | | | | | | | |
| size | particles A | | | | | | | | |
| distribution | Particle diameter dB | 80 | 100 | 150 | 400 | 80 | 80 | 80 | 80 |
| and | (nm) at the highest | | | | | | | | |
| percentage | peak for large- | | | | | | | | |
| areas of | diameter particles B | | | | | | | | |
| silica | Highest peak ratio | 4.0 | 5.0 | 7.5 | 8.0 | 4.0 | 4.0 | 4.0 | 4.0 |
| particles) | (dB/dA) | | | | | | | | |
| | Percentage area VA | 20 | 20 | 20 | 20 | 35 | 30 | 22 | 12 |
| | (%) of small- | | | | | | | | |
| | diameter particles A | | | | | | | | |
| | Percentage arca VB | 60 | 60 | 60 | 60 | 45 | 50 | 58 | 36 |
| | (%) of large- | | | | | | | | |
| | diameter particles B | | | | | | | | |
| | Area ratio (VB/(VA + | 75 | 75 | 75 | 75 | 56.25 | 62.5 | 72.5 | 75 |
| | VB) × 100) (%) | | | | | | | | |
| | Percentage area of | 80 | 80 | 80 | 80 | 80 | 80 | 80 | 48 |
| | silica particles | | | | | | | | |
| | (VA + VB) (%) | | | | | | | | |
| Inorganic | Composition | GaO | GaO | GaO | GaO | GaO | GaO | GaO | GaO |
| protective | Thickness (μm) | 1 | 1 | 1 | 1 | 1 | 1 | 1 | 1 |
| layer | | | | | | | | | |
| Evaluations | Hardness of the | 12 | 13 | 16 | 17 | 11 | 12 | 13 | 10 |
| | photosensitive layer | | | | | | | | |
| | (GPa) | | | | | | | | |
| | Break resistance of | 85 | 85 | 95 | 100 | 80 | 85 | 85 | 75 |
| | the inorganic | | | | | | | | |
| | protective layer | | | | | | | | |
| | (load at which the | | | | | | | | |
| | inorganic protective | | | | | | | | |
| | layer breaks (mN)) | | | | | | | | |

| | | Example | Example | Example | Example | Example | Example | Example |
|---|---|---|---|---|---|---|---|---|
| | | 9 | 10 | 11 | 12 | 13 | 14 | 15 |
| Coating | Average diameter | 20 | 20 | 20 | 20 | 20 | 20 | 20 |
| solution | dα (nm) of silica | | | | | | | |
| for | particles α | | | | | | | |
| charge | Average diameter | 80 | 80 | 80 | 80 | 80 | 80 | 80 |
| transport | dβ(nm) of silica | | | | | | | |
| layer | particles β | | | | | | | |
| formation | Average diameter | 4.0 | 4.0 | 4.0 | 4.0 | 4.0 | 4.0 | 4.0 |
| | ratio (dβ/dα) | | | | | | | |
| | Percentage volume | 15 | 15 | 15 | 15 | 15 | 15 | 15 |
| | Vα (%) of silica | | | | | | | |
| | particles α | | | | | | | |
| | Percentage volume | 45 | 45 | 45 | 45 | 45 | 45 | 45 |
| | Vβ(%) of silica | | | | | | | |
| | particles β | | | | | | | |
| | Percentage volume | 75 | 75 | 75 | 75 | 75 | 75 | 75 |
| | ratio (Vβ/(Vα + | | | | | | | |
| | Vβ) × 100) (%) | | | | | | | |
| | Percentage volume | 60 | 60 | 60 | 60 | 60 | 60 | 60 |
| | (Vα + Vβ) (%) | | | | | | | |
| Charge | Particle diameter | 20 | 20 | 20 | 20 | 20 | 20 | 20 |
| transport | dA (nm) at the | | | | | | | |
| layer | highest peak for | | | | | | | |
| (particle | small-diameter | | | | | | | |
| size | particles A | | | | | | | |
| distribution | Particle diameter dB | 80 | 80 | 80 | 80 | 80 | 80 | 80 |
| and | (nm) at the highest | | | | | | | |
| percentage | peak for large- | | | | | | | |
| areas of | diameter particles B | | | | | | | |
| silica | Highest peak ratio | 4.0 | 4.0 | 4.0 | 4.0 | 4.0 | 4.0 | 4.0 |
| particles) | (dB/dA) | | | | | | | |
| | Percentage area VA | 13 | 22 | 23 | 14.5 | 15.5 | 19.5 | 20.5 |
| | (%) of small- | | | | | | | |
| | diameter particles A | | | | | | | |
| | Percentage arca VB | 39 | 66 | 69 | 43.5 | 46.5 | 58.5 | 61.5 |
| | (%) of large- | | | | | | | |
| | diameter particles B | | | | | | | |
| | Area ratio (VB/(VA + | 75 | 75 | 75 | 75 | 75 | 75 | 75 |
| | VB) × 100) (%) | | | | | | | |
| | Percentage area of | 52 | 88 | 92 | 58 | 62 | 78 | 82 |
| | silica particles | | | | | | | |
| | (VA + VB) (%) | | | | | | | |
| Inorganic | Composition | GaO | GaO | GaO | GaO | GaO | GaO | GaO |
| protective | Thickness (μm) | 1 | 1 | 1 | 1 | 1 | 1 | 1 |
| layer | | | | | | | | |
| Evaluations | Hardness of the | 11 | 11 | 10 | 11 | 12 | 12 | 11 |
| | photosensitive layer | | | | | | | |
| | (GPa) | | | | | | | |
| | Break resistance of | 80 | 80 | 75 | 80 | 85 | 85 | 80 |
| | the inorganic | | | | | | | |
| | protective layer | | | | | | | |
| | (load at which the | | | | | | | |
| | inorganic protective | | | | | | | |
| | layer breaks (mN)) | | | | | | | |

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Coating | Average diameter | — | 10 | 60 | 20 | 20 | 50 |
| solution for | dα (nm) of silica | | | | | | |
| charge | particles α | | | | | | |
| transport layer | Average diameter | 80 | 80 | 400 | 70 | 500 | 150 |
| formation | dβ(nm) of silica | | | | | | |
| | particles β | | | | | | |
| | Average diameter | — | 8.0 | 6.7 | 3.5 | 25.0 | 3.0 |
| | ratio (dβ/dα) | | | | | | |
| | Percentage volume | — | 15 | 15 | 15 | 15 | 15 |
| | Vα (%) of silica | | | | | | |
| | particles α | | | | | | |
| | Percentage volume | — | 45 | 45 | 45 | 45 | 45 |
| | Vβ(%) of silica | | | | | | |
| | particles β | | | | | | |
| | Percentage volume | — | 75 | 75 | 75 | 75 | 75 |
| | ratio (Vβ/(Vα + | | | | | | |
| | Vβ) × 100) (%) | | | | | | |
| | Percentage volume | 50 | 60 | 60 | 60 | 60 | 60 |
| | (Vα + Vβ) (%) | | | | | | |
| Charge | Particle diameter | — | 10 | 60 | 20 | 20 | 50 |
| transport layer | dA (nm) at the | | | | | | |
| (particle size | highest peak for | | | | | | |
| distribution | small-diameter | | | | | | |
| and percentage | particles A | | | | | | |
| areas of silica | Particle diameter dB | 80 | 80 | 400 | 70 | 500 | 150 |
| particles) | (nm) at the highest | | | | | | |
| | peak for large- | | | | | | |
| | diameter particles B | | | | | | |
| | Highest peak ratio | — | 8.0 | 6.7 | 3.5 | 25.0 | 3.0 |
| | (dB/dA) | | | | | | |
| | Percentage area VA | — | 20 | 20 | 20 | 20 | 20 |
| | (%) of small- | | | | | | |
| | diameter particles A | | | | | | |
| | Percentage area VB | 80 | 60 | 60 | 60 | 60 | 60 |
| | (%) of large- | | | | | | |
| | diameter particles B | | | | | | |
| | Area ratio (VB/(VA + | — | 75 | 75 | 75 | 75 | 75 |
| | VB) × 100) (%) | | | | | | |
| | Percentage area of | 80 | 80 | 80 | 80 | 80 | 80 |
| | silica particles | | | | | | |
| | (VA + VB) (%) | | | | | | |
| Inorganic | Composition | GaO | GaO | GaO | GaO | GaO | GaO |
| protective | Thickness (μm) | 1 | 1 | 1 | 1 | 1 | 1 |
| layer | | | | | | | |
| Evaluations | Hardness of the | 8 | 8 | 9 | 8 | 9 | 9 |
| | photosensitive layer | | | | | | |
| | (GPa) | | | | | | |
| | Break resistance of | 65 | 65 | 70 | 65 | 70 | 70 |
| | the inorganic | | | | | | |
| | protective layer | | | | | | |
| | (load at which the | | | | | | |
| | inorganic protective | | | | | | |
| | layer breaks (mN)) | | | | | | |

From these results, it can be understood that the photoreceptors in the Examples may achieve high break resistance of the inorganic protective layer compared with the photoreceptors in the Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) An electrophotographic photoreceptor including:
a conductive substrate;
a photosensitive layer provided on or above the conductive substrate and containing inorganic oxide particles; and
an inorganic protective layer provided on the photosensitive layer, wherein:
in a particle size distribution of the inorganic oxide particles obtained through cross-sectional observation of the photosensitive layer, a highest peak for small-diameter particles A is present in a range of 20 nm to 50 nm, and a highest peak for large-diameter particles β is present in a range of 80 nm to 400 nm, with a threshold particle diameter for the small-diameter particles A and the large-diameter particles β being 60 nm; and a relationship between a particle diameter dA at the highest peak for the small-diameter particles A and a particle diameter dB at the highest peak for the large-diameter particles β satisfies formula (A1) below:

$$dB / dA \geq 4. . \qquad ( A1 )$$

(((2))) The electrophotographic photoreceptor according to (((1))), wherein:
the relationship between the particle diameter dA at the highest peak for the small-diameter particles A and the particle diameter dB at the highest peak for the large-diameter particles β satisfies formula (A2) below:

$$dB / dA \geq 6. . \qquad ( A2 )$$

(((3))) The electrophotographic photoreceptor according to (((1))) or (((2))), wherein:
for percentage areas of the inorganic oxide particles obtained through cross-sectional observation of the photosensitive layer, a relationship between a percentage area VA of the small-diameter particles A and a percentage area VB of the large-diameter particles β satisfies formula (B1) below:

$$VB / ( VA + VB ) \times 100 \geq 60 \% . \qquad ( B1 )$$

(((4))) The electrophotographic photoreceptor according to (((3))), wherein:
the relationship between the percentage area VA of the small-diameter particles A and the percentage area VB of the large-diameter particles β satisfies formula (B2) below:

$$VB / ( VA + VB ) \times 100 \geq 70 \% . \qquad ( B2 )$$

(((5))) The electrophotographic photoreceptor according to any one of (((1))) to (((4))), wherein:
a percentage area of the inorganic oxide particles obtained through cross-sectional observation of the photosensitive layer is 50% or more and 90% or less.
   (((6))) The electrophotographic photoreceptor according to (((5))), wherein:
the percentage area of the inorganic oxide particles obtained through cross-sectional observation of the photosensitive layer is 60% or more and 80% or less.
   (((7))) The electrophotographic photoreceptor according to any one of (((1))) to (((6))), wherein:
the inorganic oxide particles are silica particles.
   (((8))) The electrophotographic photoreceptor according to any one of (((1))) to (((7))), wherein:
the inorganic protective layer is a layer containing gallium oxide.
   (((9))) An electrophotographic photoreceptor including:
a conductive substrate;
a photosensitive layer provided on or above the conductive substrate and containing inorganic oxide particles; and
an inorganic protective layer provided on the photosensitive layer, wherein:
the inorganic oxide particles include inorganic oxide particles α having an average particle diameter of 20 nm or more and 50 nm or less and inorganic oxide particles β having an average particle diameter of 80 nm or more and 400 nm or less; and
a relationship between the average particle diameter da of the inorganic oxide particles α and the average particle diameter dβ of the inorganic oxide particles β satisfies formula (α1) below:

$$d β / d α \geq 4. . \qquad ( α1 ) .$$

(((10))) A process cartridge attachable to and detachable from an image forming apparatus, the process cartridge including:
the electrophotographic photoreceptor according to any one of (((1))) to (((9))).
   (((11))) An image forming apparatus including:
the electrophotographic photoreceptor according to any one of (((1))) to (((9)));
a charging device that charges a surface of the electrophotographic photoreceptor;
an electrostatic latent image forming device that forms an electrostatic latent image on the charged surface of the electrophotographic photoreceptor;
a developing device that develops, using a developer containing toner, the electrostatic latent image on the surface of the electrophotographic photoreceptor to form a toner image; and
a transfer device that transfers the toner image to a surface of a recording medium.

What is claimed is:

1. An electrophotographic photoreceptor comprising:
a conductive substrate;
a photosensitive layer provided on or above the conductive substrate and containing inorganic oxide particles; and
an inorganic protective layer provided on the photosensitive layer, wherein:
in a particle size distribution of the inorganic oxide particles obtained through cross-sectional observation of the photosensitive layer, a highest peak for small-diameter particles A is present in a range of 20 nm to 50 nm, and a highest peak for large-diameter particles β is present in a range of 80 nm to 400 nm, with a threshold particle diameter for the small-diameter particles A and the large-diameter particles β being 60 nm; and a relationship between a particle diameter dA at the highest peak for the small-diameter particles A and a particle diameter dB at the highest peak for the large-diameter particles β satisfies formula (A1) below:
$$dB / dA \geq 4. . \qquad ( A1 )$$

2. The electrophotographic photoreceptor according to claim 1, wherein:
the relationship between the particle diameter dA at the highest peak for the small-diameter particles A and the particle diameter dB at the highest peak for the large-diameter particles β satisfies formula (A2) below:
$$dB / dA \geq 6. . \qquad ( A2 )$$

3. The electrophotographic photoreceptor according to claim 1, wherein:
for percentage areas of the inorganic oxide particles obtained through cross-sectional observation of the photosensitive layer, a relationship between a percentage area VA of the small-diameter particles A and a percentage area VB of the large-diameter particles β satisfies formula (B1) below:
$$VB / ( VA + VB ) \times 100 \geq 60 \% . \qquad ( B1 )$$

4. The electrophotographic photoreceptor according to claim 3, wherein:
the relationship between the percentage area VA of the small-diameter particles A and the percentage area VB of the large-diameter particles β satisfies formula (B2) below:
$$VB / ( VA + VB ) \times 100 \geq 70 \% . \qquad ( B2 )$$

5. The electrophotographic photoreceptor according to claim 1, wherein:
a percentage area of the inorganic oxide particles obtained through cross-sectional observation of the photosensitive layer is 50% or more and 90% or less.

6. The electrophotographic photoreceptor according to claim 5, wherein:
the percentage area of the inorganic oxide particles obtained through cross-sectional observation of the photosensitive layer is 60% or more and 80% or less.

7. The electrophotographic photoreceptor according to claim 1, wherein:
the inorganic oxide particles are silica particles.

8. The electrophotographic photoreceptor according to claim 1, wherein:
the inorganic protective layer is a layer containing gallium oxide.

9. An electrophotographic photoreceptor comprising:
a conductive substrate;
a photosensitive layer provided on or above the conductive substrate and containing inorganic oxide particles; and
an inorganic protective layer provided on the photosensitive layer, wherein:
the inorganic oxide particles include inorganic oxide particles α having an average particle diameter of 20 nm or more and 50 nm or less and inorganic oxide particles β having an average particle diameter of 80 nm or more and 400 nm or less; and
a relationship between the average particle diameter da of the inorganic oxide particles α and the average particle diameter dβ of the inorganic oxide particles β satisfies formula (α1) below:
$$d β / d α \geq 4. . \qquad ( α1 )$$

10. A process cartridge attachable to and detachable from an image forming apparatus, the process cartridge comprising:
the electrophotographic photoreceptor according to claim 1.

11. A process cartridge attachable to and detachable from an image forming apparatus, the process cartridge comprising:
the electrophotographic photoreceptor according to claim 2.

12. A process cartridge attachable to and detachable from an image forming apparatus, the process cartridge comprising:
the electrophotographic photoreceptor according to claim 3.

13. A process cartridge attachable to and detachable from an image forming apparatus, the process cartridge comprising:
the electrophotographic photoreceptor according to claim 4.

14. A process cartridge attachable to and detachable from an image forming apparatus, the process cartridge comprising:
the electrophotographic photoreceptor according to claim 5.

15. A process cartridge attachable to and detachable from an image forming apparatus, the process cartridge comprising:
the electrophotographic photoreceptor according to claim 6.

16. A process cartridge attachable to and detachable from an image forming apparatus, the process cartridge comprising:
the electrophotographic photoreceptor according to claim 7.

17. A process cartridge attachable to and detachable from an image forming apparatus, the process cartridge comprising:
the electrophotographic photoreceptor according to claim 8.

18. A process cartridge attachable to and detachable from an image forming apparatus, the process cartridge comprising:
the electrophotographic photoreceptor according to claim 9.

19. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops, using a developer containing toner, the electrostatic latent image on the surface of the electrophotographic photoreceptor to form a toner image; and
a transfer device that transfers the toner image to a surface of a recording medium.

20. An image forming apparatus comprising:
the electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops, using a developer containing toner, the electrostatic latent image on the surface of the electrophotographic photoreceptor to form a toner image; and
a transfer device that transfers the toner image to a surface of a recording medium.
